(19) United States
(12) Patent Application Publication
(10) Pub. No.: US 2026/0100540 A1
(43) Pub. Date: Apr. 9, 2026

(54) ELECTRICAL PLUG STRUCTURE

(71) Applicant: LITE-ON Technology Corporation, Taipei City (TW)

(72) Inventors: Ching-Chan CHOU, Taipei City (TW); Chun-Wei WU, Taipei City (TW)

(73) Assignee: LITE-ON Technology Corporation, Taipei City (TW)

(21) Appl. No.: 18/986,721

(22) Filed: Dec. 19, 2024

(30) Foreign Application Priority Data
Oct. 8, 2024 (CN) 2024224175986

(51) Int. Cl. H01R 13/64

(52) U.S. Cl. CPC H01R 13/64

(57) ABSTRACT

An electrical plug structure comprises a socket and a plug. The socket has a socket body and two pins, the socket body has a slot and a limiting protrusion, the two pins are disposed within the slot, and the limiting protrusion is located between the two pins and separates the two pins. The plug has a plug body with a limiting recess and two plug-in holes, the plug body is fitted into the slot, the outer contour of the plug body corresponds to the inner contour of the slot, the limiting protrusion fits into the limiting recess, and the two pins are inserted into the two plug-in holes. The electrical plug structure has a non-standardized structure, which means it can only be used for connection with specific sockets and plugs, and the electrical plug structure features a structural mechanism that prevents incorrect connections with standardized plugs or sockets.

### CROSS REFERENCE TO RELATED APPLICATION

This application claims the priority benefit of Chinese Patent Application Serial Number 2024224175986, filed on Oct. 8, 2024, the full disclosure of which is incorporated herein by reference.

### BACKGROUND

### 1. Technical Field

The present disclosure relates to the field of plug and socket structures, and more particularly to an electrical plug structure.

### 2. Description of the Related Art

Regarding general electronic devices, there are regulations for standardized plug and socket designs for power supply-related products, and these regulations specify corresponding standards for plug and socket designs for standardized power supply-related products. Currently, for electronic devices with special specifications, different currents or voltages are usually required to drive them. As a result, different types of circuits and plugs are often used, and these multiple types involve non-standard plug and socket designs. If a standardized plug or socket is mistakenly connected to a non-standard socket or plug, there is a high risk of damaging the electronic device.

### SUMMARY

The present disclosure provides an electrical plug structure that, through the design of non-standardized plugs and sockets, avoids the issue of incorrect connection between standardized plugs and sockets.

To achieve the above objective, the present disclosure is implemented as follows.

An electrical plug structure is provided, comprising: a socket and a plug. The socket has a socket body and two pins, the socket body has a slot and a limiting protrusion, the two pins are disposed within the slot, and the limiting protrusion is located between the two pins and separates the two pins. The plug has a plug body with a limiting recess and two plug-in holes, the plug body is fitted into the slot, the outer contour of the plug body corresponds to the inner contour of the slot, the limiting protrusion corresponds to and fits into the limiting recess, and the two pins are inserted into the two plug-in holes.

According to an embodiment of the present disclosure, the limiting protrusion extends from the inner wall of the slot and through the space between the two pins.

According to an embodiment of the present disclosure, the limiting recess is recessed inward from the side surface of the plug body and through the space between the two plug-in holes.

According to an embodiment of the present disclosure, the slot has a first slot wall, a second slot wall, a third slot wall, and a fourth slot wall on its interior, the limiting protrusion extends from the first slot wall toward the second slot wall, and the third slot wall and the fourth slot wall are connected to both sides of the first slot wall and the second slot wall.

According to an embodiment of the present disclosure, the second slot wall is a plane adjacent to the two pins, the third slot wall is an arc surface adjacent to the outer side of one of the two pins, and the fourth slot wall is an arc surface adjacent to the outer side of the other one of the two pins.

According to an embodiment of the present disclosure, the limiting protrusion extends from the bottom of the slot to the opening of the slot, and the limiting protrusion is located between the two pins.

According to an embodiment of the present disclosure, the limiting recess is located between the two plug-in holes.

According to an embodiment of the present disclosure, the slot has a first slot wall, a second slot wall, a third slot wall, and a fourth slot wall on its interior; the first slot wall and the second slot wall are disposed along the alignment direction of the two pins; and the third slot wall and the fourth slot wall are connected to the two sides of the first slot wall and the second slot wall.

According to an embodiment of the present disclosure, the first slot wall and the second slot wall are planes adjacent to the two pins, the third slot wall is an arc surface adjacent to the outer side of one of the two pins, and the fourth slot wall is an arc surface adjacent to the outer side of the other one of the two pins.

According to an embodiment of the present disclosure, the limiting recess is a groove, the limiting protrusion is a cylindrical body, and the shape of the groove corresponds to the shape of the cylindrical body.

According to an embodiment of the present disclosure, the groove of the limiting recess is a straight slot, a cross hole, a circular hole, a triangular hole, or a T-shaped hole, and the cylindrical body of the limiting protrusion corresponds to a straight column, a cross column, a cylinder, a triangular column, or a T-shaped column.

According to an embodiment of the present disclosure, the two pins are symmetrically located on both sides of the limiting protrusion, and the two plug-in holes are symmetrically located on both sides of the limiting recess.

The electrical plug structure of the present disclosure has a non-standardized structure design for its plug and socket, which means it can only be used for connection with specific sockets and plugs. It also features a structural mechanism that prevents incorrect connections with standardized plugs or sockets.

### BRIEF DESCRIPTION OF THE DRAWINGS

The following drawings are provided to further understand the present disclosure and form a part of the present disclosure. The illustrative embodiments and their descriptions are intended to explain the present disclosure and do not constitute improper limitations. In the drawings:

FIG. 1 is a schematic diagram of the electrical plug structure of the present disclosure;

FIG. 2 is a cross-sectional view along the line A-A′ line as shown in FIG. 1;

FIG. 3 is an exploded perspective view of the first embodiment of the electrical plug structure of the present disclosure;

FIG. 4 is a sectional perspective view of the first embodiment of the electrical plug structure of the present disclosure;

FIG. 5 is an exploded perspective view of the second embodiment of the electrical plug structure of the present disclosure; and

FIG. 6 is a sectional perspective view of the second embodiment of the electrical plug structure of the present disclosure.

### DETAILED DESCRIPTIONS OF THE EMBODIMENTS

In order to further understand the present disclosure, multiple embodiments will be disclosed with drawings. For the sake of clear explanation, many implementation details will be mentioned in the following description. However, it should be understood that these details are not intended to limit the present disclosure. That is, in some embodiments of the present application, these details are not essential. Additionally, for the sake of simplifying the drawing, some conventional structures and components are illustrated in a simplified schematic manner. In the following embodiments, identical or similar components are denoted by the same reference numbers.

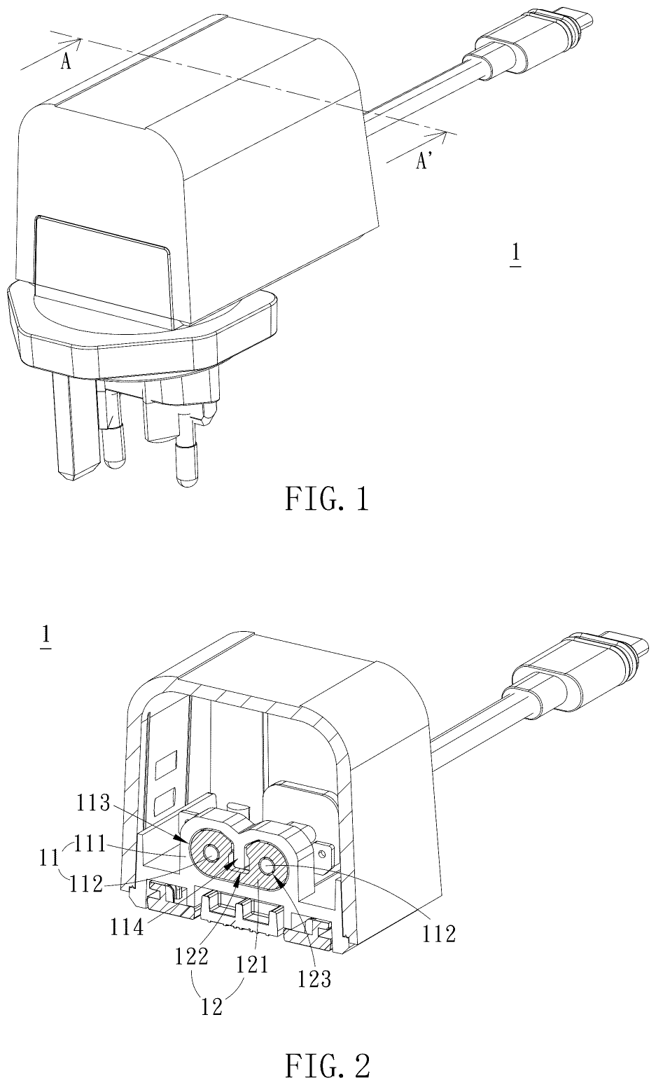

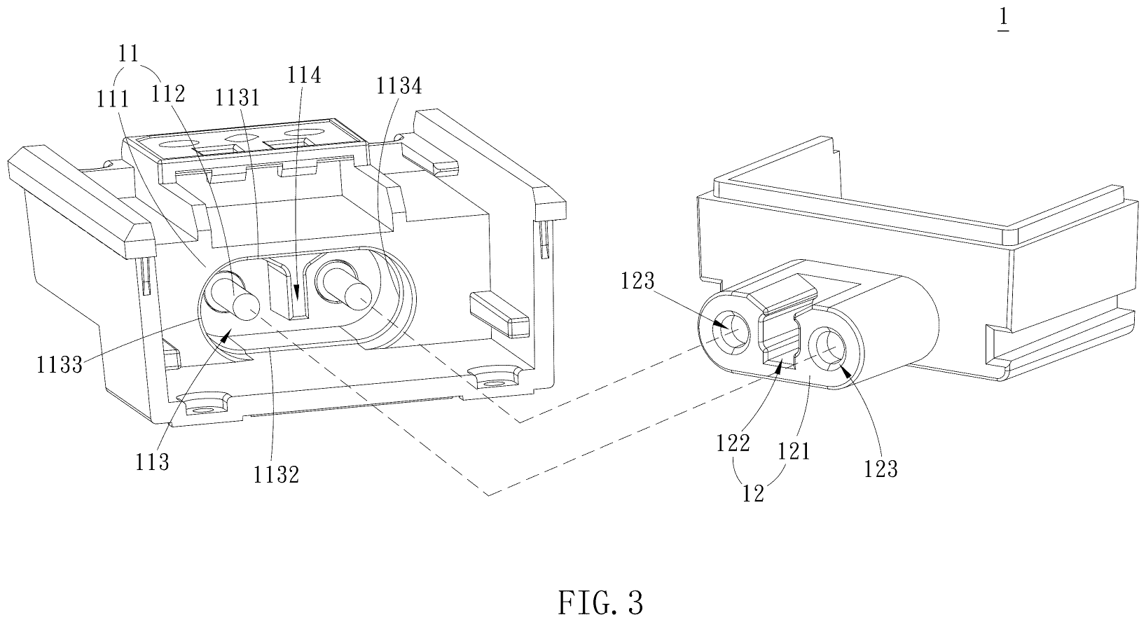

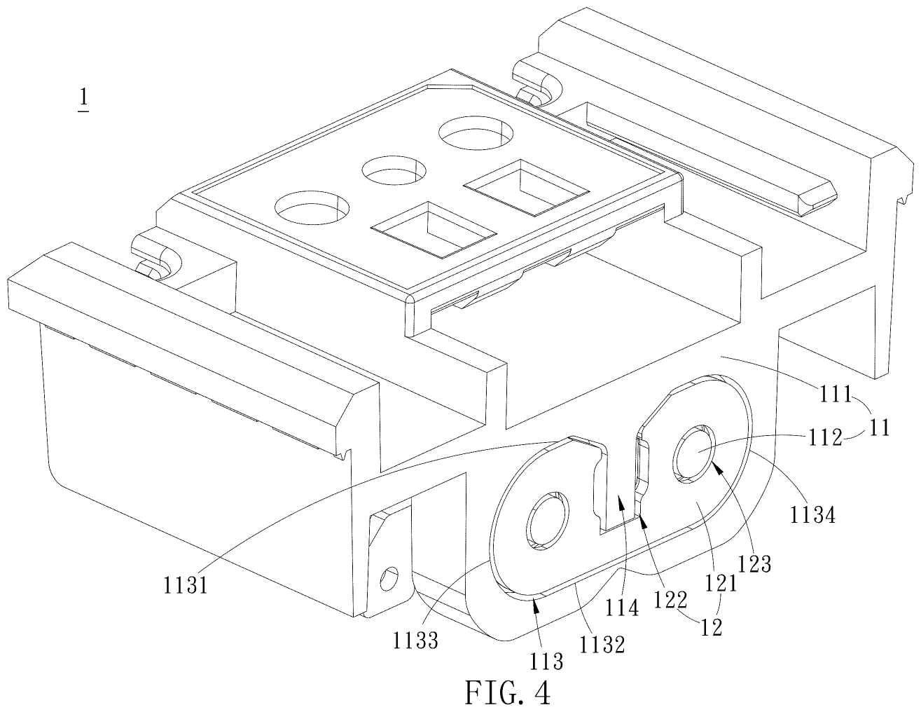

Please refer to FIG. 1 to FIG. 4. FIG. 1 is a schematic diagram of the electrical plug structure according to the present disclosure, FIG. 2 is a cross-sectional view along the A-A′ line as shown in FIG. 1, FIG. 3 is an exploded perspective view of the first embodiment of the electrical plug structure of the present disclosure, and FIG. 4 is a sectional perspective view of the first embodiment of the electrical plug structure of the present disclosure. As shown in the figures, the present disclosure provides an electrical plug structure 1, which comprises a socket 11 and a plug 12. The socket 11 has a socket body 111 and two pins 112, and the socket body 111 has a slot 113 and a limiting protrusion 114. The two pins 112 are disposed within the slot 113. The limiting protrusion 114 is located between the two pins 112 and separates the two pins 112. The plug 12 has a plug body 121, which is equipped with a limiting recess 122 and two plug-in holes 123. The plug body 121 is fitted into the slot 113, and the outer contour of the plug body 121 corresponds to the inner contour of the slot 113. The limiting protrusion 114 corresponds to and fits into the limiting recess 122, and the two pins 112 pass through the two plug-in holes 123. The design of the socket 11 and the plug 12 of the electrical plug structure 1 is a non-standardized structure.

Please refer to FIG. 3 and FIG. 4 again. In this embodiment, the slot 113 of the socket 11 has a first slot wall 1131, a second slot wall 1132, a third slot wall 1133, and a fourth slot wall 1134 on the interior of the slot 113. The limiting protrusion 114 extends from the first slot wall 1131 and toward the second slot wall 1132; that is, the limiting protrusion 114 extends from the inner wall of the first slot wall 1131 of the slot 113 and through the space between the two pins 112, where the two pins 112 are symmetrically located on both sides of the limiting protrusion 114. The third slot wall 1133 and the fourth slot wall 1134 are connected to the two sides of the first slot wall 1131 and the second slot wall 1132. Moreover, the second slot wall 1132 is a plane adjacent to the two pins 112, the third slot wall 1133 is an arc surface adjacent to the outer side of one of the two pins 112, and the fourth slot wall 1134 is an arc surface adjacent to the outer side of the other one of the two pins 112.

As described above, the outer contour of the plug body 121 of the plug 12 corresponds to the inner contour of the slot 113 of the socket 11. The end surface of the plug body 121 has two plug-in holes 123 symmetrically located on both sides of the limiting recess 122. The side surface of the plug body 121 has a limiting recess 122, and the limiting recess 122 is recessed inward from the side surface of the plug body 121 and through the space between the two plug-in holes 123. That is, the depth of the groove of the limiting recess 122 is greater than the depth of the two plug-in holes 123, and the groove of the limiting recess 122 extends toward the end surface of the plug body 121 to form an opening. In other words, the two plug-in holes 123 and the opening of the limiting recess 122 are located on the same end surface. In addition, the side surface contour of the plug body 121 corresponds to the first slot wall 1131, the second slot wall 1132, the third slot wall 1133, and the fourth slot wall 1134 of the slot 113.

In this embodiment, the plug 12 is inserted into the slot 113 of the socket 11, aligning the limiting recess 122 of the plug body 121 with the limiting protrusion 114 inside the slot 113. This allows the limiting protrusion 114 to enter the groove of the limiting recess 122 through the opening in the end surface of the plug body 121. In other words, the position of the plug body 121 is constrained by the structures of the limiting recess 122 and the limiting protrusion 114. Further, the structural positions of the limiting recess 122 and the limiting protrusion 114 also restrict the orientation of the plug body 121 when inserted into the slot 113, effectively preventing the user from inserting it with the opposite orientation. The limiting protrusion 114 can be extended toward the first slot wall 1131 according to the user's needs such that the direction of insertion of the plug body 121 into the slot 113 of the socket 11 can be changed. In addition, the two pins 112 inside the slot 113 will be aligned with and also inserted into the two plug-in holes 123 of the plug body 121. The outer contour of the plug body 121 matches the inner contour of the slot 113 such that the plug body 121 of the plug 12 and the slot 113 of the socket 11 can be completely engaged, making the combination of the socket 11 and the plug 12 stable.

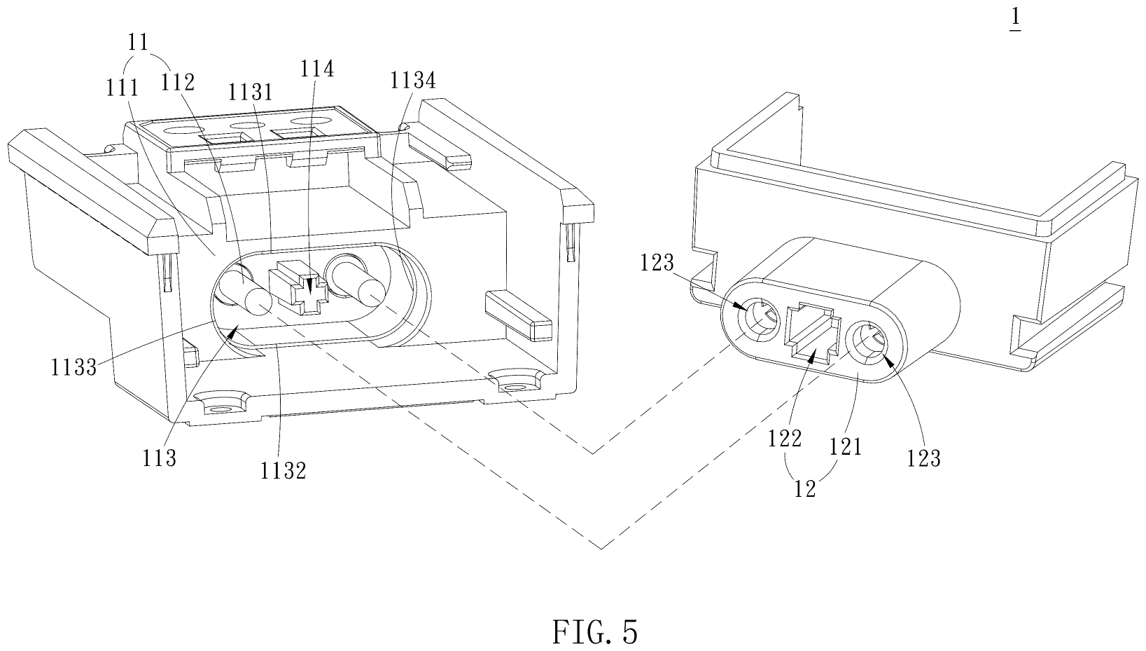

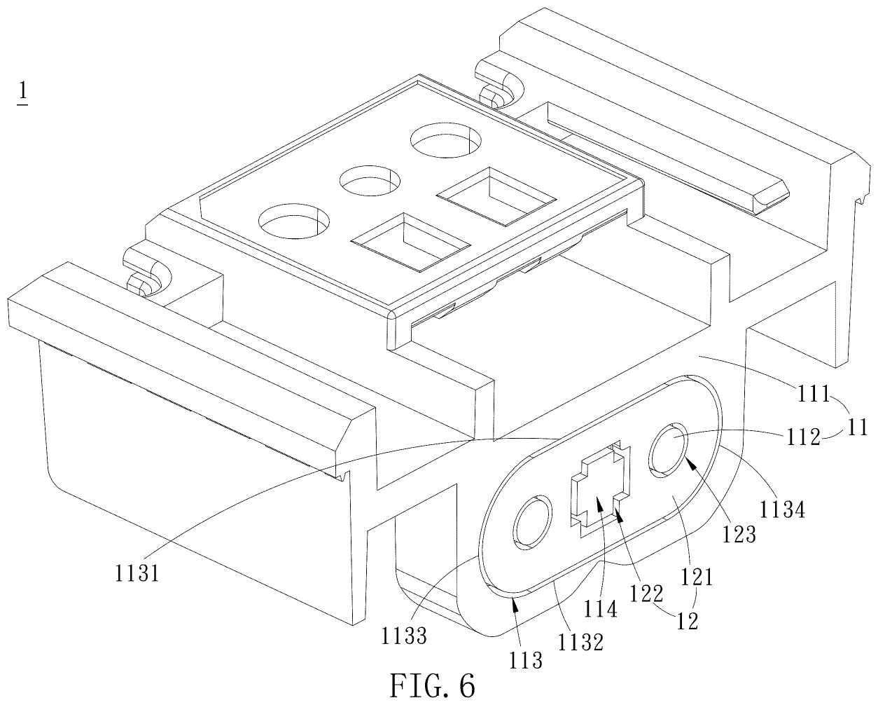

Please refer to FIG. 5 and FIG. 6. FIG. 5 is an exploded perspective view of the second embodiment of the electrical plug structure, and FIG. 6 is a sectional perspective view of the second embodiment of the electrical plug structure. As shown in the drawings, the difference between this embodiment and the first embodiment lies in the structure of the limiting protrusion 114 and the limiting recess 122. In this embodiment, the limiting protrusion 114 extends from the bottom of the slot 113 to the opening, and the limiting protrusion 114 of the slot 113 is located between the two pins 112. The limiting recess 122 of the plug body 121 corresponds to the limiting protrusion 114 of the slot 113 such that the limiting recess 122 is located between the two plug-in holes 123. The slot 113 has a first slot wall 1131, a second slot wall 1132, a third slot wall 1133, and a fourth slot wall 1134 inside the slot 113; the first slot wall 1131 and the second slot wall 1132 are disposed along the arrangement direction of the two pins 112; and the first slot wall 1131 and the second slot wall 1132 are planes adjacent to the two pins 112. The third slot wall 1133 and the fourth slot wall 1134 are connected to both sides of the first slot wall 1131 and the second slot wall 1132. The third slot wall 1133 is an arc surface adjacent to the outer side of one of the pins 112, and the fourth slot wall 1134 is an arc surface adjacent to the outer side of the other one of the two pins 112 on the outside.

As described above, in this embodiment, the limiting recess 122 is a groove, and the limiting protrusion 114 is a cylindrical body. The shape of the groove of the limiting recess 122 corresponds to the shape of the cylindrical body of the limiting protrusion 114. The groove of the limiting recess 122 may be a straight slot, a cross hole, a circular hole, a triangular hole, or a T-shaped hole respectively corresponding to a straight column, a cross column, a cylinder, a triangular column, or a T-shaped column for receiving the cylindrical body of the limiting protrusion 114. This embodiment does not limit the shape of the limiting recess 122 or the limiting protrusion 114, and the shapes can be adjusted according to the user's requirements.

In this embodiment, when the plug 12 is inserted into the slot 113 of the socket 11, the limiting recess 122 of the plug body 121 aligns with the limiting protrusion 114 inside the slot 113. In this embodiment, the limiting protrusion 114 is located at the center of the slot 113, and the limiting recess 122 corresponding to the limiting protrusion 114 is also located at the center. If the limiting protrusion 114 in this embodiment is a non-directional cylindrical body, such as a straight column, a cross column, or a cylinder, the combination of the limiting protrusion 114 and the limiting recess 122 will not restrict the orientation of the plug during insertion. In other words, the plug 12 can be inserted into the slot 113 in both upright and inverted orientations. If the limiting protrusion 114 in this implementation is a directional cylindrical body, such as a triangular column (e.g., with the angle edge facing up and the straight edge facing down as a constraint) or a T-shaped column, then the combination of the limiting protrusion 114 and the limiting recess 122 imposes a directional constraint. That is, the aforementioned plug body 121 must be inserted into the slot 113 with the correct orientation.

In summary, the present disclosure provides an electrical plug structure comprising a socket and a plug. The socket has a limiting protrusion, and the plug has a limiting recess. The combination of the limiting protrusion and the limiting recess serves to restrict the connection between standardized plugs and non-standardized sockets, or between non-standardized plugs and standardized sockets. At the same time, the limiting protrusion and the limiting recess also function to constrain the insertion orientation of non-standardized plugs and non-standardized sockets. The design of the plug and the socket in the present electrical plug structure is non-standardized, meaning it can only be used for specific sockets and plugs, and it incorporates a structural mechanism to prevent incorrect connections with standardized plugs or sockets.

The foregoing description presents and explains several preferred embodiments of the present disclosure. However, as previously noted, the present disclosure is not limited to the disclosed forms and should not be interpreted as excluding other embodiments. It may be applied in various other combinations, modifications, and environments, and adaptations can be made within the scope of the inventive concept disclosed herein, utilizing the teachings provided or through technical knowledge in the relevant field. Modifications and variations made by those skilled in the art without departing from the spirit and scope of this disclosure should be included within the scope of the claims attached to this disclosure.

What is claimed is:

1. An electrical plug structure, comprising:
a socket, having a socket body and two pins, the socket body having a slot and a limiting protrusion, the two pins being disposed within the slot, and the limiting protrusion being located between the two pins and separating the two pins; and
a plug, having a plug body, the plug body having a limiting recess and two plug-in holes, the plug body being fitted into the slot, the outer contour of the plug body corresponding to the inner contour of the slot, the limiting protrusion corresponding to and fitting into the limiting recess, and the two pins being inserted into the two plug-in holes.

2. The electrical plug structure according to claim 1, wherein the limiting protrusion extends from the inner wall of the slot and through the space between the two pins.

3. The electrical plug structure according to claim 2, wherein the limiting recess is recessed inward from the side surface of the plug body and through the space between the two plug-in holes.

4. The electrical plug structure according to claim 2, wherein the slot has a first slot wall, a second slot wall, a third slot wall, and a fourth slot wall on its interior, the limiting protrusion extends from the first slot wall toward the second slot wall, and the third slot wall and the fourth slot wall are connected to both sides of the first slot wall and the second slot wall.

5. The electrical plug structure according to claim 4, wherein the second slot wall is a plane adjacent to the two pins, the third slot wall is an arc surface adjacent to the outer side of one of the two pins, and the fourth slot wall is an arc surface adjacent to the outer side of the other one of the two pins.

6. The electrical plug structure according to claim 1, wherein the limiting protrusion extends from the bottom of the slot to the opening of the slot, and the limiting protrusion is located between the two pins.

7. The electrical plug structure according to claim 6, wherein the limiting recess is located between the two plug-in holes.

8. The electrical plug structure according to claim 6, wherein the slot has a first slot wall, a second slot wall, a third slot wall, and a fourth slot wall on its interior; the first slot wall and the second slot wall are disposed along the alignment direction of the two pins; and the third slot wall and the fourth slot wall are connected to the two sides of the first slot wall and the second slot wall.

9. The electrical plug structure according to claim 8, wherein the first slot wall and the second slot wall are planes adjacent to the two pins, the third slot wall is an arc surface adjacent to the outer side of one of the two pins, and the fourth slot wall is an arc surface adjacent to the outer side of the other one of the two pins.

10. The electrical plug structure according to claim 6, wherein the limiting recess is a groove, the limiting protrusion is a cylindrical body, and the shape of the groove corresponds to the shape of the cylindrical body.

11. The electrical plug structure according to claim 10, wherein the groove of the limiting recess is a straight slot, a cross hole, a circular hole, a triangular hole, or a T-shaped hole, and the cylindrical body of the limiting protrusion corresponds to a straight column, a cross column, a cylinder, a triangular column, or a T-shaped column.

12. The electrical plug structure according to claim 1, wherein the two pins are symmetrically located on both sides of the limiting protrusion, and the two plug-in holes are symmetrically located on both sides of the limiting recess.
